(19) United States
(12) Patent Application Publication
(10) Pub. No.: US 2009/0319317 A1
(43) Pub. Date: Dec. 24, 2009

(54) Or Relating To A Method and System for Testing

(75) Inventors: Agostino Colussi, Rome (IT); Domenico D'Alterio, Rome (IT); Alessandro Donatelli, Rome (IT); Pietro Marella, Rome (IT); Claudio Marinelli, Latina (IT); Luigi Pichetti, Rome (IT); Riccardo Rossi, Roma (IT)

Correspondence Address: IBM CORPORATION;INTELLECTUAL PROPERTY LAW, 11501 BURNET ROAD, AUSTIN, TX, 78758, US

(73) Assignee: International Business Machines Corporation, Armonk, NY (US)

(21) Appl. No.: 12/490,594

(22) Filed: Jun. 24, 2009

(30) Foreign Application Priority Data
Jun. 24, 2008 (EP) 08158821.2

(51) Int. Cl. G06Q 10/00; G06Q 50/00

(52) U.S. Cl. 705/7

(57) ABSTRACT

A method of evaluating a cost associated with a test scenario, which test scenario comprises one or more branches making up a use case, the method comprising the steps of: determining a first parameter based on the complexity of the use case; determining a second parameter which indicates the criticality of the use case; determining a third parameter which indicates an execution cost of each action and decision point of the use case; determining a fourth parameter which indicates the priority of each branch of the use case; determining a fifth parameter which indicates the classification of each test parameter for each branch of the use case; determining a cost associated with the test scenario, based on a predetermined calculation using two or more of the first, second, third, fourth and fifth parameters.

### FIELD OF THE INVENTION

The invention relates to a method and system for testing, particularly but not exclusively for software testing.

### BACKGROUND ART

The test phase of a software product, one of the fundamental steps in the production of the document, is often referred to as a “test design” which describes a set of test scenarios needed to certify the quality of the software being tested. During this activity, the test designer must create appropriate test scenarios based on a use case model created by a development team. Use cases artifacts needed to communicate with the customer, developer, technical writer and/or tester are in accordance with a rational unified process (RUP). A use case typically describes how a software product under development may interact with a person or other system to satisfy the specific requirement. The design work needed to be created by the tester defines test scenarios starting from a use case and following a well-defined procedure is called a use case base test (UCBT).

Once the list of scenarios has been created by the tester, the tester will classify them using an orthogonal defect classification (ODC) trigger. The tester must then prioritize and assign an execution cost to each scenario. This is carried out manually and is time-consuming, error prone and has a high maintenance cost.

There have been a number of solutions proposed to solve the first part of the above identified problem, namely the generation of test scenarios. But the solutions do not solve other problems or address the methodology of classification of scenarios and simple execution cost analysis.

US2005/0144529A1 discloses a method for deriving software tests from use cases which are represented in an activity diagram. The test case scenarios are derived by applying coverage metrics on the activity diagram so that the activities can be matched with an appropriate test. A test idea document is then generated along with system test scenarios which are created by concatenating the test case scenarios with a system walk-through. The system test scenarios are then augmented if possible and used to vary the test case scenarios result before a final test design document is produced. This solution still suffers from many of the disadvantages identified above.

### SUMMARY OF THE INVENTION

The present invention is directed to a method, computer program product and system as defined in the independent claims.

More particularly, the present invention discloses a method of evaluating a cost associated with a test scenario, which test scenario comprises one or more branches making up a use case, the method comprising the steps of: determining a first parameter based on the complexity of the use case; determining a second parameter which indicates the criticality of the use case; determining a third parameter which indicates an execution cost of each action and decision point of the use case; determining a fourth parameter which indicates the priority of each branch of the use case; determining a fifth parameter which indicates the classification of each test parameter for each branch of the use case; determining a cost associated with the test scenario, based on a predetermined calculation using two or more of the first, second, third, fourth and fifth parameters.

The present invention further discloses apparatus for evaluating a cost, associated with a test scenario, which test scenario comprises one or more branches making up a use case, the apparatus comprising: a first module for determining a first parameter based on the complexity of the use case; a second module for determining a second parameter which indicates the criticality of the use case; a third module for determining a third parameter which indicates an execution cost of each action and decision point of the use case; a fourth module for determining a fourth parameter which indicates the priority of each branch of the use case; a fifth module for determining a fifth parameter which indicates the classification of each test parameter for each branch of the use case; a cost determination module for determining a cost associated with the test scenario, based on a predetermined calculation using two or more of the first, second, third, fourth and fifth parameters.

Other aspects of the invention can be seen in the appended dependent claims.

### BRIEF DESCRIPTION OF THE DRAWINGS

Reference will now be made by way of example to the accompanying drawings, in which: —

FIG. 1 is a diagram showing an overview of the system for testing, in accordance with an embodiment of the invention, by way of example.

FIG. 2 is a flowchart of the method steps, in accordance with an embodiment of the invention, by way of example.

### DETAILED DESCRIPTION OF THE PREFERRED EMBODIMENT

In order to classify the test scenarios, the following summary of definitions of the classification will be employed herein. The ODC triggers are defined as the following: coverage, variation, sequencing, interaction, backward compatibility and rare. Each of these triggers has a guideline defined for an ODC scenario classification. These guidelines are as follows;

A simple basic flow is defined as coverage (C).

A simple alternative flow is defined as variation (V).

A complex flow where the final expected result depends on the previous results is defined as sequencing (S). In this situation, it is not possible to reach the final expected result without success of a previous result.

A complex flow where there is an interaction between different functions or difference instances of the same function is defined as interaction (I)

A flow that deals with backward compatibility issues is defined as backward compatibility (B).

flow that is an alternative and that can only be achieved in rare and unusual conditions is defined as rare (R).

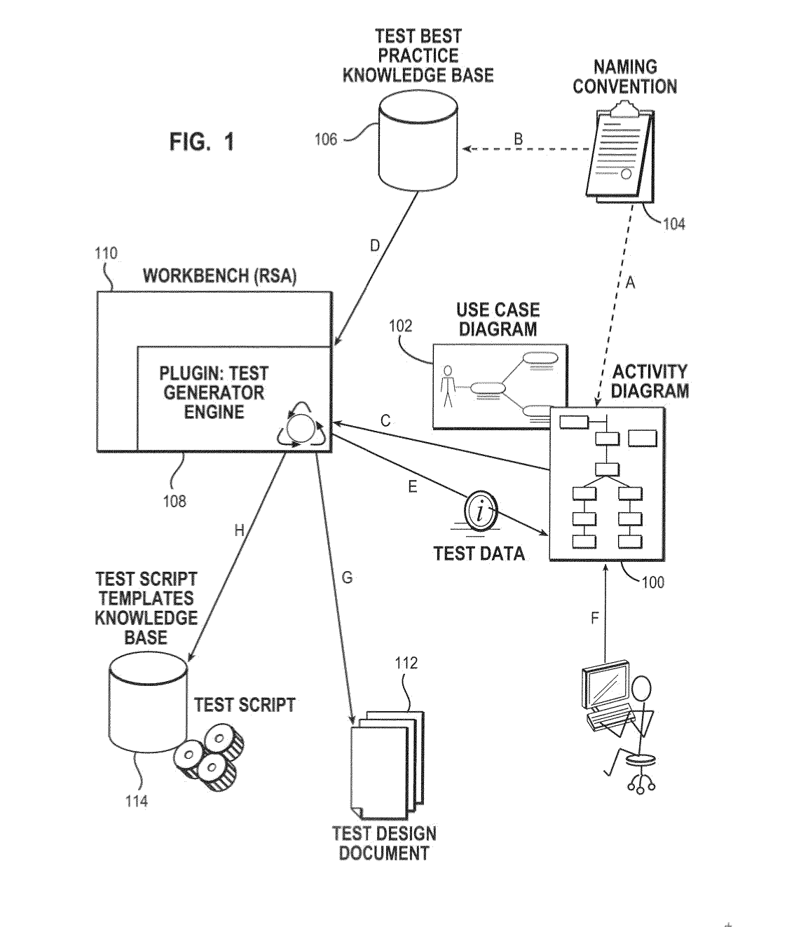

By referring initially to FIG. 1, a system overview diagram is shown. An activity diagram 100 is used to define the behavior of a use case 102 which has been built in accordance with a predefined naming convention (NC) 104. This is indicated by Arrow A. The same naming convention is also used in a test best practice knowledge base (TBPKB) 106 to define a set of decision point actions. The decision point actions will define the cost for the execution of the action and the ODC classification attribute that is dependent on each alternative test pattern for the specific action (happy paths, error condition, variation and/or boundary condition). An example is an INSTALL_LOCATION decision point to test an installation use case. The test pattern available for this decision point includes path missing (e.g., wrong path), valid (e.g., existing path) and with special characters (e.g., with spaces). When an installation of a product is tested, it is necessary to test different values in the field “INSTALLATION_LOCATION” to be sure that the installation works well. To do this, different tests (variation) of the same installation are carried out thereby changing the “INSTALLATION_LOCATION” field using different test patterns such as missing path, valid path and path with special characters such as spaces. This step is indicated by arrow B.

The activity diagram is then used as an input to a test generator engine (TGE) 108 as illustrated by arrow C. The test generator engine can form part of a workbench 110 in the form of a plug-in, or can be a stand-alone process. Data from the test best practice knowledge base is also input into the test generator engine as is shown by arrow D. The test generator engine uses the information from the TBPKB to produce a set of test data which includes cost, ODC classification, test pattern and so on. The test data may then be added to the activity diagram as notes as indicated by arrow E. Any user can optionally validate the test data (see arrow F), for example in an enhanced activity diagram, which is enriched with test information. In an alternative embodiment, the test data may be manually added into the activity diagram by a user.

The test generator engine 108 then uses the new tagged activity diagram to generate a test design document 112, as illustrated by arrow G. The test design document includes a test case matrix and test case procedure. As indicated by arrow H, the test generator engine may select a test script from the test script template knowledge base, 114. The script template may be matched with the test pattern defined as indicated by arrow B above. The script template is started and actual data extracted from the TBPKB inserted in order to generate test scripts for test execution. An example could be a script template based on the ISMP response file used to test an installation use case. In general, the template is filled with actual data extracted from the TBPKB.

The system thus enables a tester to be supported in the complex analysis of use case diagrams including the ability to classify with ODC trigger, priority and execution cost the tests in scenarios generated by the UCBT procedure. In addition, an estimate of test effort is also dynamically generated.

The method in accordance with the present invention is composed of two main phases. These main phases are the data insertion phase and the test generation phase, each will be described in detail below.

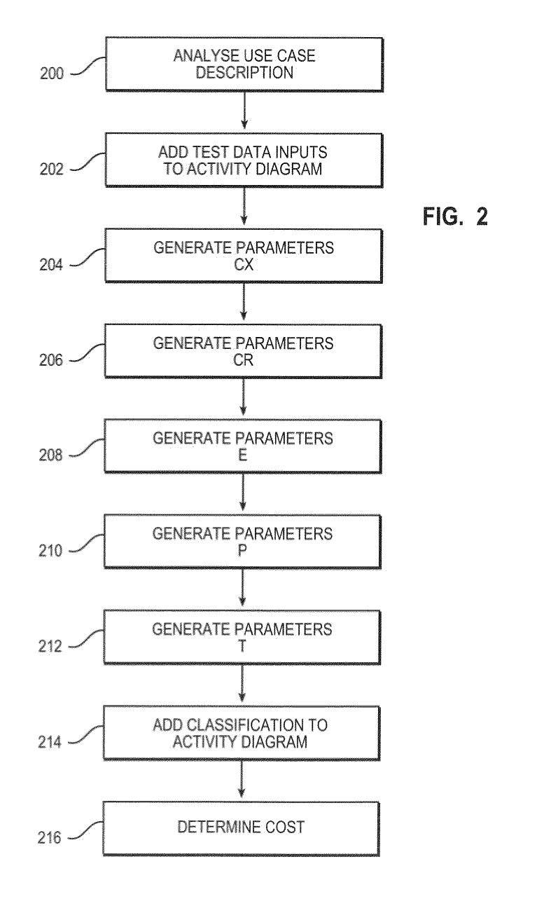

The data insertion phase will be described with reference to FIG. 2. Initially the use case description is analyzed as shown in step 200 in order to add test data to an activity diagram as shown in step 202. The use case description may be derived from a UML activity diagram. The test data must be applied to each branch or event of the activity diagram in order to generate a set of test scenarios. This is then the input value used in carrying out the use case flows. In accordance with the present invention, it is also required that the activity diagram be supplemented with information needed to support the classification of the generated scenarios (for example, ODC trigger, priority and execution costs). In order for this to be carried out, the following processes takes place.

At step 204, a parameter (CX) is generated which gives an indication of the complexity of the whole use case. For example, if there is some type of interaction with complex middleware or other equipment then this may imply that the use case is complex.

At step 206, a parameter (CR) is generated in order to describe if the whole use case is critical or not. For example, traffic control software would be critical and the parameter CR would have an high value. Similarly, other software may not be critical and as such this parameter would have a low value.

At step 208, a parameter (E) is generated to give an estimation of the execution cost. This execution cost must be applied to each actual action nodes and decision point in the activity diagram.

At step 210, a parameter (P) is used to estimate the priority of the use case. It is used in such a way that it is applied to each branch of the activity diagram.

At step 212, parameter (T) is used to estimate the ODC trigger classification. This is applied to each test data in each branch of the activity diagram.

Finally, a determination of cost, priority and classification (e.g., ODC scenario classification) is made at step 216 as described in the second phase below:

The apparatus of FIG. 1 includes modules associated with each step of the process as described in FIG. 2, though they may not be called this with respect to FIG. 1.

The second phase of the method relates to test generation. In this part of the invention, the system applies the following method in order to combine the input parameters (CX, CR, E, P and T) so as to classify the generated scenarios (for example, ODC trigger, priority or execution cost). The system generates a scenarios matrix and for each scenario a set of parameters is determined. The set of parameters may include a step-by-step procedure, an ODC trigger, a priority and an execution cost. The above-mentioned parameter CX is used together with E to estimate the execution cost of the generated scenarios. In addition, the parameter CR is used together with P to estimate the priority of each generated scenario. Finally, parameter T is used to estimate the ODC trigger of each generated scenario.

Execution cost is determined as follows:

Execution Cost=CX*SUM(E for each step)

Execution cost is determined by considering that a test scenario is a list of step to be executed including a number of action or decision points. The sum of all execution costs (E) in each step of the list of steps is then determined. A multiplication of this sum with the complexity (CX) of the use case is determined. Typically, the value of CX various between 0 and 2, for example a CX values of 1 is normal, 1.5 is high and 2 is very high. It should be noted that cost need not relate just to monetary cost, but can extend to the cost in another characteristic such as in respect of anything for example time, effort, processing, power, capacity, etc. or any combination of things.

The priority can be calculated in a similar manner as defined below:

Priority=CR*SUM(P for each branch)

In this situation, a branch in a test scenario is considered as the path traversed after a decision point. The list of all priorities (P) in each branch carried out or crossed by the list of steps is determined. As above, the value of P can vary; where 1 is low, 2 is medium and 3 is high. A multiplication of the sum of P and critical value (CR) of the use case is determined. CR values are generally; 1 is normal, 1.5 is critical and 2 is very critical.

The classification (ODC trigger) can be calculated as follows:

ODC Trigger=(C if all T=C) or (V if exist T=V and not S,I,B,R) or (S if exist T=S and not I,B,R) or (I if exist T=I and not B,R) or (B if exist T=B and not R) or (R if exist T=R)

In this situation, a test data line is considered as an input data inserted in each branch in a test scenario. So for each test scenario, there is a list of input data (one test data line for each branch traversed by the steps). Then, for each scenario the list of input data is parsed to extract the ODC triggers T. The various scenarios are classified as follows:

The scenario is classified as coverage if the T of the data inputs are all classified as C;

The scenario is classified as variation if the T of the data inputs are classified as a mix of C and V (however, at least one V must be present);

The scenario is classified as sequencing if the T of the data inputs are classified as a mix of C, V and S (where at least one S must be present);

The scenario is classified as interaction if the T of the data inputs are classified as a mix of C, V, S and I (where at least one I must be present);

The scenario is classified as backward compatibility if the T of the data inputs are classified as a mix of C, V, S, I and B (where at least one B must be present); and

The scenario is classified as rare if the T of the data inputs are classified as a mix of C, V, S, I, B and R (where at least one R must be present).

By adopting this method and system in the test phase, there are a number of benefits. For example, there is improved productivity in determining and writing test scenarios. There are improvements in the quality of the tests achieved and the maintainability of scenarios and tests. In addition, the estimation of execution costs for each scenario is associated with the complexity of the use case. The priority attributed to the scenarios depends on the critical values associated with the use case. Classification of scenarios which have ODC triggers are easily identified based on the different paths traversed.

The system in accordance with the present invention is capable of parsing the activity diagram in order to determine the minimum number of independent paths. Subsequently, specific test data values belonging to that path can be retrieved and used as an input by testers. The system then applies the values to each independent path thereby generating test scenario matrices and the step-by-step procedures.

The advantages provided by the present invention includes the ability to have a clearly defined and common approach for determining and estimation of execution costs of the scenario. This is achieved by assigning the costs of single actions and using these to form a more complex use case. Similarly prioritization of scenarios also depends on the critical value of the use case. This can also be been repeatable, by determining priorities for a smaller subsets rather than the whole. A number of advantages are achieved by classifying the ODC triggers dependent on paths and types of test values. The testers can more easily maintain the scenarios and less time is required to react to design changes, since this then only requires modification of test inputs and regeneration of test cases. The writing of the scenarios will also result in increased productivity since most of the tedious or time consuming elements are carried out by the present invention. The system and method also permits discovery of all paths of the activity diagram which will ensure an increased test coverage of the use case paths.

In addition, the method and system provide the capability to generate a dynamic “ballpark” estimation of test effort directly from the use case without adding test data to the activity diagram.

The “ballpark” estimates can be achieved as described below. In the first instance, the independent paths from the use case diagram are extracted. The system then assigns the mean cost (M) to each action in the list of steps carried out in a given scenario. This may be based on historic data (H) and the complexity (CX) of the scenario and may be assigned by a design team or otherwise specified. In other words: M=CX*H.

The number of variation test cases (TC) into which each scenario can be split (with an acceptable test quality) can be determined from the critical value (CR) of the use case, either as assigned by a design team or otherwise. This can be expressed as TC=CR*3, the 3 is the “normal” test of one mean value and two boundary conditions. The test effort for the use case is estimated by considering the number of steps (N) of the independent path; the mean cost of each step (M); and the number of test cases (TC). Switched test effort can be expressed as follows:

Test Effort=SUM(N*M*TC for each independent path) This ensures that a common definition of test effort estimation can be readily determined on a repeatable basis. The test effort estimation is available at a very early stage in the developmental cycle which can help with decision-making processes. If there are changes in the design in the test effort, the estimation can be quickly reevaluated. In addition, various different solutions can be evaluated to determine the optimum from the test effort point of view.

It will be appreciated that examples other than those described above may exist, which fall within the scope of the present invention. For example, the steps may take place in different orders and by different modules.

1. A method of evaluating a test scenario, which test scenario comprises one or more branches making up a use case, the method:
generating a test scenario, by a test generation engine, to test a data processing system storing the test scenario in a computer memory;
determining a first parameter based on the complexity of the use case;
determining a second parameter which indicates the criticality of the use case;
determining a third parameter which indicates an execution cost of each action and decision point of the use case;
determining a fourth parameter which indicates the priority of each branch of the use case;
determining a fifth parameter which indicates the classification of each test parameter for each branch of the use case;
determining a cost associated with the test scenario, based on a predetermined calculation using two or more of the first, second, third, fourth and fifth parameters; and presenting the cost on a computer display to a user.

2. The method of claim 1, wherein the step of determining the cost comprises calculating a value from the first and third parameters.

3. The method of claim 1, further comprising evaluating a priority associated with the test scenario based on a predetermined calculation using two or more of the first, second, third, fourth and fifth parameters.

4. The method of claim 3, wherein the step of determining the priority comprises calculating a value from the second and fourth parameters.

5. The method of claim 1, further comprising evaluating a classification associated with the test scenario based on a predetermined calculation using two or more of the first, second, third, fourth and fifth parameters.

6. The method of claim 5, further comprising determining the classification based on a logic analysis of all parameters to determine which is the relevant classification.

7. The method of claim 6, wherein the logical analysis comprises determining if the classification includes one or more than one parameter.

8. The method of claim 7, wherein if the classification includes just one parameter selecting the relevant parameter as the classification.

9. The method of claim 7, wherein if the classification includes more than one parameter, selecting the classification to be the second parameter if there are just first and second parameters; the third parameter if there are first, second and third parameters; the fourth parameter if there are first, second, third and fourth parameters, and the fifth parameter if there are first, second, third, fourth and fifth parameters.

10. A data processing system comprising:
a test generation engine for generating a test scenario wherein the test generation engine and the test scenario are resident in a computer memory and the test scenario is used to test a data processing system;
a first module for determining a first parameter based on the complexity of the use case;
a second module for determining a second parameter which indicates the criticality of the use case;
a third module for determining a third parameter which indicates an execution cost of each action and decision point of the use case;
a fourth module for determining a fourth parameter which indicates the priority of each branch of the use case;
a fifth module for determining a fifth parameter which indicates the classification of each test parameter for each branch of the use case;
a sixth module for determining a cost associated with the test scenario, based on a predetermined calculation using two or more of the first, second, third, fourth and fifth parameters; and
a computer display for displaying the cost to a user.

11. A computer program product in a computer storage memory comprising instructions when said computer program product is executed on a computer system which perform the method comprising:
generating a test scenario, by a test generation engine, to test a data processing system storing the test scenario in a computer memory;
determining a first parameter based on the complexity of the use case;
determining a second parameter which indicates the criticality of the use case;
determining a third parameter which indicates an execution cost of each action and decision point of the use case;
determining a fourth parameter which indicates the priority of each branch of the use case;
determining a fifth parameter which indicates the classification of each test parameter for each branch of the use case;
determining a cost associated with the test scenario, based on a predetermined calculation using two or more of the first, second, third, fourth and fifth parameters; and presenting the cost on a computer display to a user.
